(19) United States
(12) Patent Application Publication
(10) Pub. No.: US 2014/0345052 A1
(43) Pub. Date: Nov. 27, 2014

(54) LIGHTING PAD

(71) Applicant: HIEVER CO., LTD., Taichung City (TW)

(72) Inventor: Tony HUANG, TAICHUNG CITY (TW)

(73) Assignee: HIEVER CO., LTD., Taichung City (TW)

(21) Appl. No.: 14/285,103

(22) Filed: May 22, 2014

(30) Foreign Application Priority Data
May 23, 2013 (TW) 102209622

(51) Int. Cl. B25H 5/00; F21V 33/00

(52) U.S. Cl. CPC B25H 5/00; F21V 33/008; F21Y 2103/025
USPC 5/417

(57) ABSTRACT

A body-protection board with lighting functionality includes a board body that has a recessed portion and a cavity. A control set is deposited in the cavity and connected to a power source and has a switch. A fighting apparatus is deposited in the recessed portion of the body-protection board. The lighting apparatus has a thickness smaller than or equal to a depth of the recessed portion, so that the lighting apparatus is received in the recessed portion without bulging out from a top surface of the board body of the body-protection board.

### BACKGROUND OF THE INVENTION

1. Technical Field

The present invention relates to auxiliary tools for mechanics, and more particularly, to a body-protection board with lighting functionality.

2. Description of Related Art

In many mechanics' operations, body-protection boards or other protective mats are used to protect mechanics from frictional injury and stains. For example, when performing repair or maintenance of vehicles, a mechanic often has to kneel down or lie beneath chassis of the vehicle he/she is working on. In this case, a body-protection board is needed to protect the mechanic's knees and other body parts. When lying on the body-protection board with his/her both hands operating hand tools, it is almost impossible for the mechanic to spare a hand for holding a lighting apparatus that is really necessary for the dark and narrow operational space under the vehicle chassis. This predicament makes the operation inconvenient.

### SUMMARY OF THE INVENTION

In view of the inconvenience as mentioned above, the primary objective of the present invention is to provide a body-protection board that has lighting functionality and offer protection to its user.

For achieving the above objective, the disclosed body-protection board with lighting functionality comprises a board body. The board body has a top surface and a bottom surface reverse against the top surface. A recessed portion is depressed from the top surface of the body-protection board toward the bottom surface of the body-protection board. The body-protection board has a cavity formed on the top surface. A control set has a switch and is connected to a power source. The control set is deposited in a cavity of the body-protection board. A lighting apparatus is deposited in the recessed portion of the body-protection board and has a thickness that is smaller than or equal to a depth of the recessed portion, so that when the lighting apparatus is received in the recessed portion, the lighting apparatus does not bulge out from the top surface of the body-protection board.

### BRIEF DESCRIPTION OF THE DRAWINGS

FIG. 1 is a perspective view of a first embodiment of the present invention,

FIG. 2 is an exploded view of the first embodiment of the present invention.

FIG. 3 is a partial, cross-sectional view of the first embodiment of the present invention.

FIG. 4 is a perspective view of a second embodiment of the present invention

FIG. 5 is a perspective view of a third embodiment of the present invention.

FIG. 6 is a perspective view of a fourth embodiment of the present invention.

FIG. 7 is a perspective view of a fifth embodiment of the present invention.

FIG. 8 is an applied view of the present invention.

### DETAILED DESCRIPTION OF THE INVENTION

For further illustrating the means and functions by which the present invention achieves the certain objectives, the following description, in conjunction with the accompanying drawings and preferred embodiments, is set forth as below to illustrate the implement, structure, features and effects of the subject matter of the present invention.

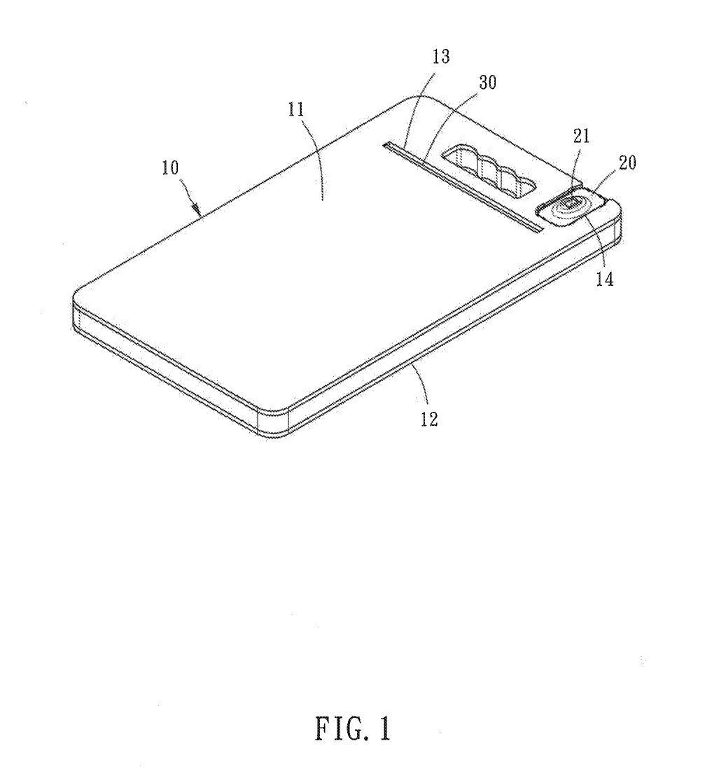

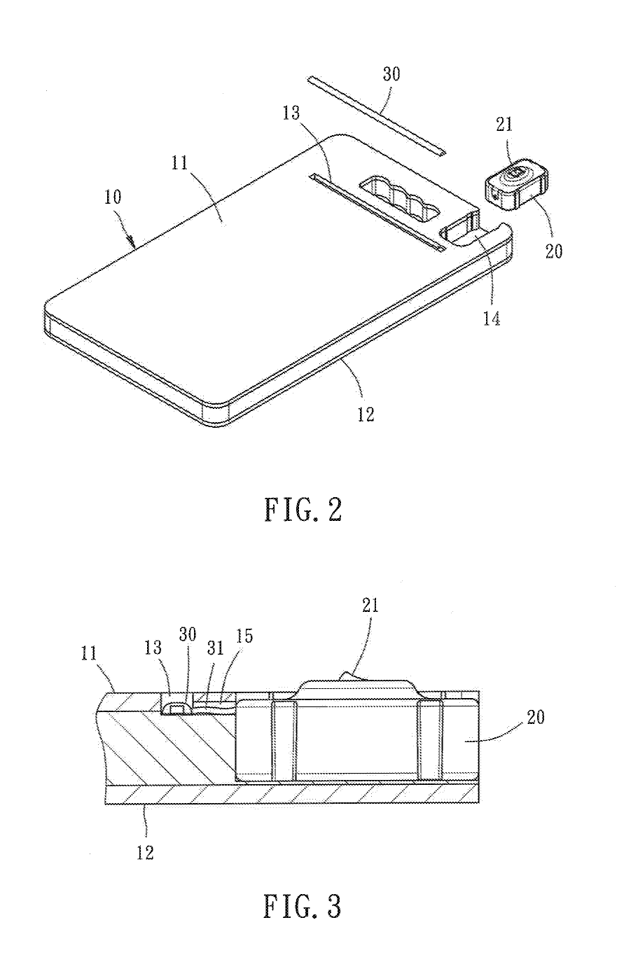

Please refer to FIG. 1 through FIG. 3 for a first embodiment of the present invention. As shown, the disclosed body-protection board is constructed from the following components.

A board body (10) has atop surface (11) and a bottom surface (12) reverse against the top surface (11). A recessed portion (13) is depressed from the top surface (11) of the board body (10) toward the bottom surface (12). The recessed portion (13) may be linear, curved, looped or of other shapes. The top surface (11) further has a cavity (14). Between the recessed portion (13) and the cavity (14), there is a connecting portion (15) for receiving a power cord running between the both. Said connecting portion (15) can be a recesses or a connecting hole. The board body (10) may be rectangular, round, triangular or of other shapes. The body-protection board may be made of metal, wood, rubber, foam or plastic, without limitation. In the present embodiment, the board body (10) is an EVA-made rectangular board, and the top surface (11) has a lengthwise recessed portion (13), while the connecting portion (15) is a connecting hole connecting the recessed portion (13) with the cavity (14).

A control set (20) has a switch (21) and is connected to a power source. The power source connected to the control set may be a battery provided in the control set, or the grid, or a vehicle power source, or AC power. The battery may be separated from the control set in terms of arrangement.

A lighting apparatus (30) is deposited in the recessed portion (13) of the board body, and has a thickness smaller than or equal to the depth of the recessed portion (13), so that when received in the recessed portion (13), the lighting apparatus (30) does not bulge out from the top surface (11) of the board body. The lighting apparatus (30) is connected to a power cord (31) that is electrically connected with the control set (20) through the connecting portion (15), so that the lighting apparatus (30) is controlled by the control set (20) and the power cord is not exposed at the surfaces of the board body (10), In the present embodiment, the lighting apparatus (30) is an LED strip, which has a plurality of LEDs attached to a soft circuit board and packaged by a transparent material. The LED strip may form a long extended light-emitting source. A soft circuit board can provide more comfortable feel.

The first embodiment of the present invention provides a body-protection board having a linear lighting apparatus and allowing a user to sitting or kneeling thereon. By using the device of the first embodiment of the present invention, a user can have his/her working area properly illuminated, and can have his/her both hands free to work. Additionally, since the lighting apparatus (30) dose not raise from the board body (10), it is unlikely to make the user uncomfortable and is unlikely to get damaged by falling tools or by the user's tread.

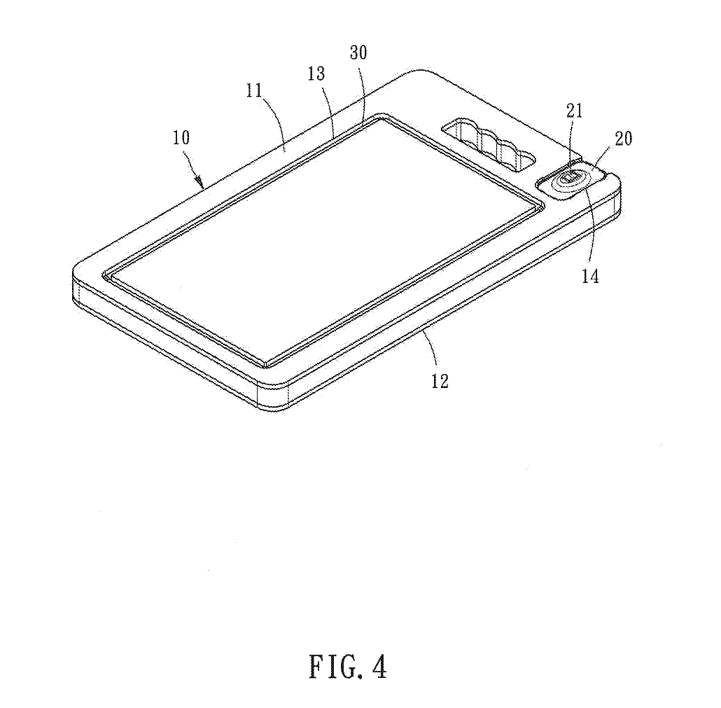

FIG. 4 depicts a second embodiment of the present invention. The disclosed body-protection board with lighting functionality has a board body (10), the body-protection board has a top surface (11) and a bottom surface (12) reverse against the top surface (11). A recessed portion (13) is depressed from the top surface (11) of the board body (10) toward the bottom surface (12). The top surface (11) further has a cavity (14). Between the recessed portion (13) and the cavity (14), there is a connecting portion (15) connecting the both.

A control set (20) has a switch (21) and is connected to a power source.

A lighting apparatus (30) is deposited in the recessed portion (13) of the board body, and has a thickness smaller than or equal to the depth of the recessed portion (13), so that when received in the recessed portion (13), the lighting apparatus (30) does not bulge out from the top surface (11) of the body-protection board. The lighting apparatus (30) is connected to a power cord (31) that is electrically connected with the control set (20) through the connecting portion (15). In the present embodiment, the lighting apparatus is an LED strip, which has a plurality of LEDs attached to a circuit board and packaged by a transparent material.

The present embodiment is different from the previous embodiment by the board body (10) having the recessed portion (13) formed as rectangular loop. A lighting apparatus (30) is arranged along the recessed portion. The lighting apparatus may be a single looped LED strip, or may be four connected LED strips extending along the four edges of the board body (10). The present embodiment provides the larger illuminated area as compared with the previous embodiment.

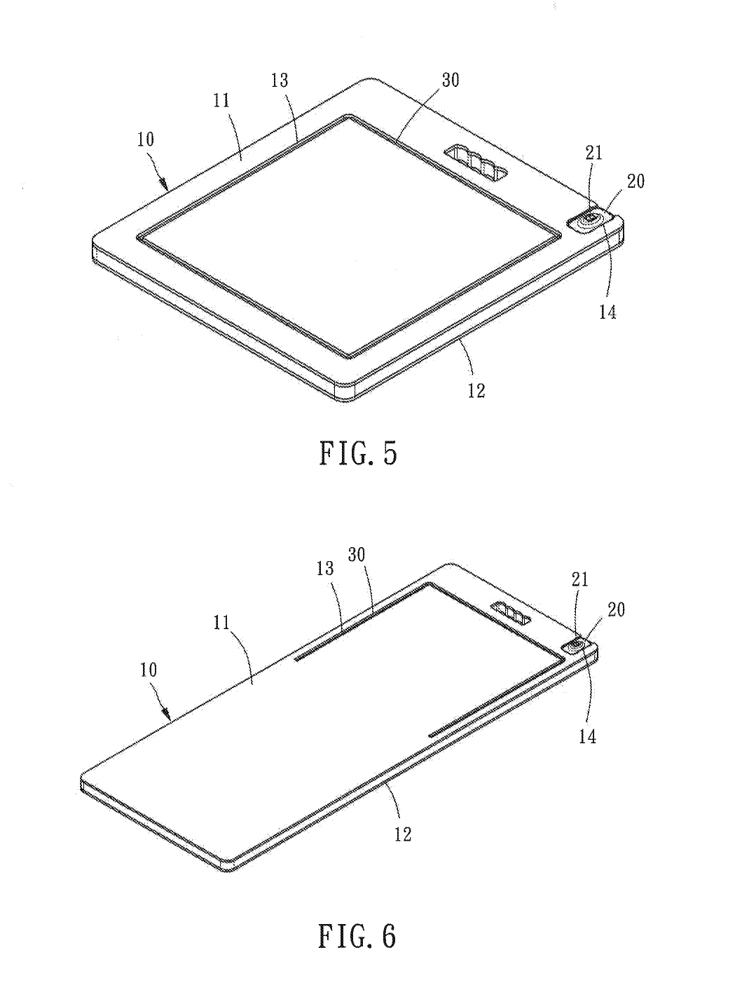

FIG. 5 illustrated a third embodiment of the present invention. The body-protection board with lighting functionality has a board body (10), a control set (20) and a lighting apparatus (30), that are similar to their counterparts in the previous embodiment. The present embodiment is different because the board body (10) is larger than that of the previous embodiment in area and is a square board, so there is no directional limitation when a user uses this device.

FIG. 6 provides a fourth embodiment of the present invention. The body-protection board with lighting functionality has a board body (10). The body-protection board has a top surface (11) and a bottom surface (12) reverse against the top surface (11). A recessed portion (13) is depressed from the top surface (11) of the board body (10) toward the bottom surface (12). The top surface (11) further has a cavity (14). Between the recessed portion (13) and the cavity (14), there is a connecting portion (15) connecting the both.

A control set (20) has a switch (21) and is connected to a power source.

A lighting apparatus (30) is deposited in the recessed portion (13) of the board body, and has a thickness smaller than or equal to the depth of the recessed portion (13), so that when received in the recessed portion (13), the lighting apparatus (30) does not bulge out from the top surface (11). The lighting apparatus (30) is connected to a power cord (31) that is electrically connected with the control set (20) through the connecting portion (15). In the present embodiment, the lighting apparatus (30) is an LED strip.

The present embodiment is different from the previous embodiment by having a longer board body (10) and having the recessed portion (13) segmented into three parts. Therein, two parts extend along two lengthwise edges of the board body (10) and the other part extends along a widthwise edge of the board body (10) to connect ends of the two lengthwise parts, so that the recessed portion (13) has a U-like shape and embraces one end of the board body (10), on which a user can lie to work with his/her working area illuminated.

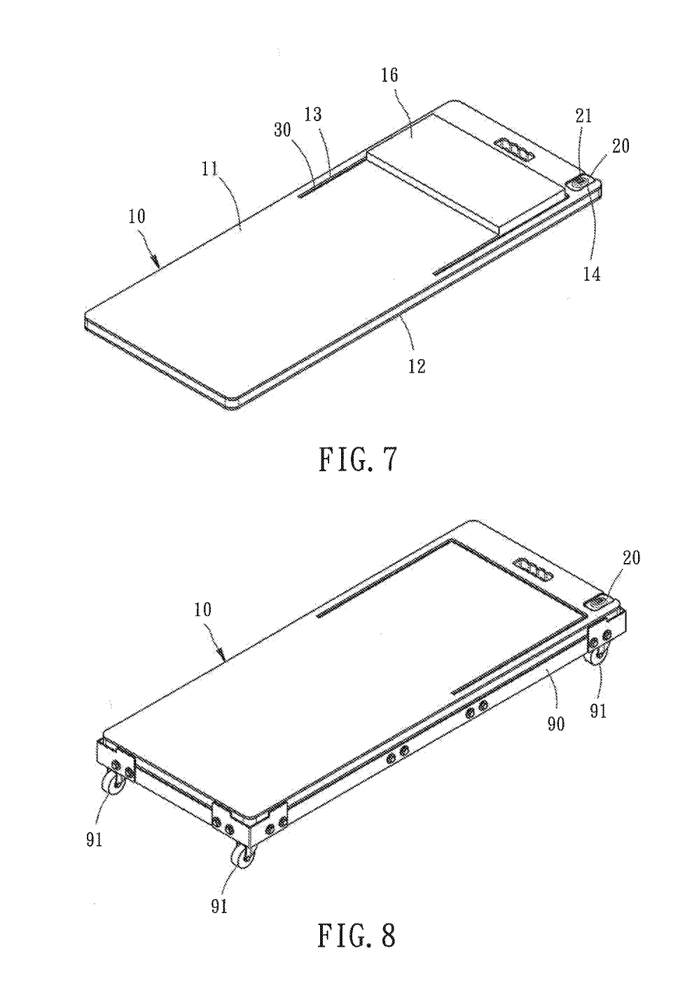

FIG. 7 shows a fifth embodiment of the present invention. Similar to the previous embodiment, the body-protection board with lighting functionality comprises a board body (10), a control set (20) and a lighting apparatus (30). The present embodiment is different from the previous embodiment because the board body (10) further comprise a headrest (16) raised from the board body (10). The recessed portion (13) circles the headrest (16), so the present embodiment provides better illumination around the user's upper half body.

The present invention may be directly put on the ground and may be placed on a creeper board. As shown in FIG. 8, the board body (10) of the fourth embodiment of the present invention is mounted on a creeper board (90). Since the creeper board is well known in the art, the detailed description is herein omitted. In this case, the board body (10) can be directly mounted on the top of the creeper board (90). The board body (10) also has the control set (20) and the lighting apparatus (30). The creeper board (90) is supported by casters (91) so that when the board body (10) is mounted on the creeper board (90), the combination can move conveniently to provide the user with mobile protection and illumination.

What is claimed is:

1. A body-protection board with lighting functionality, comprising:
a board body, having a top surface and a bottom surface reverse against the top surface, wherein a recessed portion is depressed from the top surface of the body-protection board toward the bottom surface of the body-protection board, and a cavity is formed on the top surface of the body-protection board;
a control set deposited in the cavity, wherein the control set is connected to a power source and has a switch; and
a lighting apparatus deposited in the recessed portion of the body-protection board, wherein the lighting apparatus is electrically connected to and controlled by the control set.

2. The body-protection board with lighting functionality of claim 1, wherein the lighting apparatus has a thickness that is smaller than or equal to a depth of the recessed portion.

3. The body-protection board with lighting functionality of claim 2, wherein the lighting apparatus is an LED strip that is made by mounting a plurality of LEDs on a circuit board and packaging the circuit board with a transparent material.

4. The body-protection board with lighting functionality of claim 1, further comprising a connecting portion between the recessed portion and the cavity for connecting the recessed portion and the cavity.

5. The body-protection board with lighting functionality of claim 4, wherein the connecting portion is a connecting hole.

6. The body-protection board with lighting functionality of claim 1, wherein the recessed portion is lengthwise.

7. The body-protection board with lighting functionality of claim 1, wherein the recessed portion is looped.

8. The body-protection board with lighting functionality of claim 3, wherein the circuit board is a soft circuit board and packaged by a transparent material.
